(19) United States
(12) Patent Application Publication
(10) Pub. No.: US 2024/0373883 A1
(43) Pub. Date: Nov. 14, 2024

(54) FOOD PROCESSING SYSTEMS AND MICROWAVE SUPPRESSION SYSTEMS

(71) Applicant: Alkar-RapidPak, Inc., Lodi, WI (US)

(72) Inventors: Craig R. Bonneville, Black Earth, WI (US); Paul Alton, Mason, NH (US); Ryan Gitzlaff, Pardeeville, WI (US); Ajitesh Yadav, Madison, WI (US); Graeme Bunce, Goffstown, NH (US); Mark Fitzgerald, Nashua, NH (US)

(73) Assignee: Alkar-RapidPak, Inc., Lodi, WI (US)

(21) Appl. No.: 18/658,519

(22) Filed: May 8, 2024

Related U.S. Application Data
(60) Provisional application No. 63/500,765, filed on May 8, 2023.

(51) Int. Cl. A23L 5/10; H05B 6/76; H05B 6/78

(52) U.S. Cl. CPC A23L 5/15; H05B 6/76; H05B 6/782

(57) ABSTRACT

A food processing system for processing a food product includes a module with a microwave generating device configured to generate microwave energy to process the food product, a conveyor extending through the module and configured to convey the food product through the module, and a microwave suppression system configured to prevent leakage of the microwave energy from the food processing system. The microwave suppression system including a pin choke assembly with a plurality of pin chokes that is selectively movable relative to the conveyor to thereby vary a clearance distance between the plurality of pin chokes and the conveyor.

### CROSS-REFERENCE TO RELATED APPLICATION

The present disclosure is based on and claims priority to U.S. Provisional Patent Application No. 63/500,765 filed May 8, 2023, the disclosure of which is incorporated herein by reference.

### FIELD

The present disclosure relates to food processing systems, and specifically to food processing systems with microwave suppression systems.

### BACKGROUND

The following U.S. patent and U.S. patent application Publication are incorporated herein by reference in entirety.

U.S. Pat. No. 11,412,584 discloses food processing machines for processing a food product having a housing, a conveyor for conveying the food product through the cavity, and a convection heating system for heating food products. A microwave launch box system is configured to emit microwave energy to further heat the food products.

U.S. Patent Application Publication No. 2022/0346198 discloses food processing machines for processing a food product with a microwave generating device configured to generate microwave energy. A waveguide assembly is configured to receive the microwave energy, direct the microwave energy along a waveguide axis, and subsequently direct the microwave energy to heat the food product.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

In certain independent examples, a food processing system for processing a food product includes a module with a microwave generating device configured to generate microwave energy to process the food product, a conveyor extending through the module and configured to convey the food product through the module, and a microwave suppression system configured to prevent leakage of the microwave energy from the food processing system. The microwave suppression system includes a pin choke assembly that is selectively movable relative to the conveyor to thereby vary a clearance distance between the pin choke assembly and the conveyor.

Optionally the pin choke assembly is located vertically above the conveyor and the pin choke assembly is vertically moveable relative to the conveyor. Optionally the conveyor is configured to convey the food product in an upstream direction or a downstream direction and the pin choke assembly is translatable along the conveyor in the upstream direction or the downstream direction. Optionally the pin choke assembly includes a first plurality of pin chokes that extend toward the conveyor. Optionally the pin choke assembly includes a second plurality of pin chokes that extend away from the conveyor. Optionally the first plurality of pin chokes extend perpendicular to the second plurality of pin chokes. Optionally the second plurality of pin chokes extend toward the module. Optionally the microwave suppression system includes a wall with a slot defined therein and the pin choke assembly includes a pin or rod that extends into the slot such the slot guides movement of the pin or rod and thereby the pin choke assembly. Optionally the slot includes a first slot end that prevents movement of the pin or rod in a first direction and sets a maximum clearance distance between the pin choke assembly and the conveyor and a second slot end opposite the first slot end that prevents movement of the pin or rod in a first direction and sets a minimum clearance distance between the pin choke assembly and the conveyor. Optionally the microwave suppression system includes an actuator that moves the pin choke assembly. Optionally the pin choke assembly is a first pin choke assembly and the clearance distance is a first clearance distance and a second pin choke assembly is selectively movable relative to the conveyor to thereby vary a second clearance distance between the pin choke assembly and the conveyor and the second pin choke assembly is longitudinally spaced apart from the first pin choke assembly along the conveyor. Optionally the first pin choke assembly and the second pin choke assembly are independently movable relative to each other. Optionally the microwave suppression system includes a first actuator for moving the first pin choke assembly and a second actuator for moving the second pin choke assembly. Optionally the first pin choke assembly and the second pin choke assembly are located vertically above the conveyor and vertically moveable relative to the conveyor. Optionally the first pin choke assembly includes a first plurality of pin chokes that extend toward the conveyor and the second pin choke assembly includes a first plurality of pin chokes and a second plurality of pin chokes that extend away from the conveyor. Optionally the first plurality of pin chokes extend perpendicular to the second plurality of pin chokes. Optionally the second plurality of pin chokes extend toward the module.

In certain independent examples, a method for processing a food product in a food processing system includes processing, with a module configured to generate microwaves, the food product; conveying, with a conveyor, the food product through the module; moving a first pin choke assembly from a second position in which a second clearance distance is defined between the first pin choke assembly and the conveyor to a first position in which a first clearance distance is defined between the first pin choke assembly and the conveyor, the first clearance distance is greater than the second clearance distance; and moving a second pin choke assembly from a second position in which a second clearance distance is defined between the first pin choke assembly and the conveyor to a first position in which a first clearance distance is defined between the first pin choke assembly and the conveyor, wherein the first clearance distance is greater than the second clearance distance.

Optionally the method can include: sensing, with a sensor, a food product on a conveyor; tracking, with a control system, location of the food product on the conveyor as the food product is conveyed by the conveyor; the moving of the first pin choke assembly from the second position to the first position when the control system determines that the food product approaches the first pin choke assembly thereby permitting the food product to pass below the first pin choke assembly; and/or the moving of the second pin choke assembly from the second position to the first position when the control system determines that the food product approaches the second pin choke assembly thereby permitting the food product to pass below the second pin choke assembly. Optionally the food product is one food product in a plurality of food products, the method can include: sensing, with a sensor, a leading end of the plurality of food products on the conveyor; tracking, with a control system, location of the leading end of the plurality of food products being conveyed on the conveyor; the moving of the first pin choke assembly from the second position to the first position when the control system determines that the leading end of the plurality of food products approaches the first pin choke assembly thereby permitting the food product to pass below the first pin choke assembly; the moving of the second pin choke assembly from the second position to the first position occurs when the control system determines that the leading end of the plurality of food products approaches the first pin choke assembly thereby permitting the food product to pass below the first pin choke assembly; sensing, with the sensor, a trailing end of the plurality of food products on the conveyor; tracking, with the control system, location of the trailing end of the plurality of food products being conveyed on the conveyor; moving of the first pin choke assembly from the first position to the second position when the control system determines that the trailing end of the plurality of food products clears the first pin choke assembly to thereby prevent microwaves from leaking from the module; and/or moving of the second pin choke assembly from the first position to the second position when the control system determines that the trailing end of the plurality of food products clears the second pin choke assembly to thereby prevent microwaves from leaking from the module. Optionally the first pin choke assembly and the second pin choke assembly are part of a first microwave suppression system that is located upstream of the module, a second microwave suppression system is located downstream of the module and includes a first pin choke assembly and a second pin choke assembly, and the food product is one food product in a plurality of food products; the method can include: sensing, with a sensor, a leading end of the plurality of food products on the conveyor; tracking, with a control system, location of the leading end of the plurality of food products being conveyed on the conveyor; the moving of the first pin choke assembly of the first microwave suppression system from the second position to the first position occurs when the control system determines that the leading end of the plurality of food products approaches the first pin choke assembly thereby permitting the food product to pass below the first pin choke assembly; the moving of the second pin choke assembly of the second microwave suppression system from the second position to the first position occurs when the control system determines that the leading end of the plurality of food products approaches the first pin choke assembly thereby permitting the food product to pass below the first pin choke assembly; moving the first pin choke assembly of the second microwave suppression system from the second position to the first position when the control system determines that the leading end of the plurality of food products approaches the first pin choke assembly thereby permitting the food product to pass below the first pin choke assembly; moving of the second pin choke assembly of the second microwave suppression system from the second position to the first position when the control system determines that the leading end of the plurality of food products approaches the second pin choke assembly thereby permitting the food product to pass below the second pin choke assembly; sensing, with the sensor a trailing end of the plurality of food products on the conveyor; tracking, with the control system, location of the trailing end of the plurality of food products being conveyed on the conveyor; moving of the first pin choke assembly of the first microwave suppression system from the first position to the second position when the control system determines that the trailing end of the plurality of food products clears the first pin choke assembly to thereby prevent microwaves from leaking from the module; moving of the second pin choke assembly of the first microwave suppression system from the first position to the second position when the control system determines that the trailing end of the plurality of food products clears the second pin choke assembly to thereby prevent microwaves from leaking from the module; moving of the first pin choke assembly of the second microwave suppression system from the first position to the second position when the control system determines that the trailing end of the plurality of food products clears the first pin choke assembly to thereby prevent microwaves from leaking from the module; and/or moving of the second pin choke assembly of the second microwave suppression system from the first position to the second position when the control system determines that the trailing end of the plurality of food products clears the second pin choke assembly to thereby prevent microwaves from leaking from the module.

In certain independent examples, a food processing system for processing a food product includes a module with a microwave generating device configured to generate microwave energy to process the food product, a conveyor extending through the module and configured to convey the food product through the module, and a microwave suppression system configured to prevent leakage of the microwave energy from the food processing system. The microwave suppression system including a pin choke assembly with a plurality of pin chokes that is selectively movable relative to the conveyor to thereby vary a clearance distance between the plurality of pin chokes and the conveyor.

Optionally the pin choke assembly is located vertically above the conveyor and the pin choke assembly is vertically moveable relative to the conveyor. Optionally the conveyor is configured to convey the food product in an upstream direction or a downstream direction and the pin choke assembly is translatable along the conveyor in the upstream direction or the downstream direction. Optionally the plurality of pin chokes are a first plurality of pin chokes that extend toward the conveyor. Optionally the pin choke assembly includes a second plurality of pin chokes that extend away from the conveyor. Optionally the first plurality of pin chokes extend perpendicular to the second plurality of pin chokes. Optionally the second plurality of pin chokes extend toward the module. Optionally the microwave suppression system includes a wall with a slot defined therein and the pin choke assembly includes a guide member that extends into the slot such the slot guides movement of the guide member and thereby the pin choke assembly. Optionally the slot includes a first slot end that prevents movement of the guide member in a first direction and sets a maximum clearance distance between the plurality of pin chokes and the conveyor and the slot has a second slot end opposite the first slot end that prevents movement of the guide member in a first direction and sets a minimum clearance distance between the plurality of pin chokes and the conveyor. Optionally the microwave suppression system includes an actuator that moves the pin choke assembly. Optionally the pin choke assembly is a first pin choke assembly and the clearance distance is a first clearance distance and a second pin choke assembly is selectively movable relative to the conveyor to thereby vary a second clearance distance between the pin choke assembly and the conveyor. Optionally the second pin choke assembly is longitudinally spaced apart from the first pin choke assembly along the conveyor. Optionally the first pin choke assembly and the second pin choke assembly are independently movable relative to each other. Optionally the microwave suppression system further comprising a first actuator for moving the first pin choke assembly and a second actuator for moving the second pin choke assembly. Optionally the first pin choke assembly and the second pin choke assembly are located vertically above the conveyor and vertically moveable relative to the conveyor. Optionally the plurality of pin chokes are a first plurality of pin chokes that extend toward the conveyor and the second pin choke assembly includes a first plurality of pin chokes and a second plurality of pin chokes that extend away from the conveyor. Optionally the first plurality of pin chokes extend perpendicular to the second plurality of pin chokes. Optionally the second plurality of pin chokes extend toward the module.

In certain independent examples, a method for processing a food product in a food processing system includes processing, with a module configured to generate microwaves, the food product, conveying, with a conveyor, the food product through the module, moving a first pin choke assembly from a second position in which a second clearance distance is defined between the first pin choke assembly and the conveyor to a first position in which a first clearance distance is defined between the first pin choke assembly and the conveyor, the first clearance distance is greater than the second clearance distance, and/or moving a second pin choke assembly from a second position in which a second clearance distance is defined between the first pin choke assembly and the conveyor to a first position in which a first clearance distance is defined between the first pin choke assembly and the conveyor, the first clearance distance is greater than the second clearance distance.

Optionally the method can include sensing, with a sensor, a food product on a conveyor, the moving of the first pin choke assembly from the second position to the first position when the control system determines that the food product approaches the first pin choke assembly thereby permitting the food product to pass below the first pin choke assembly, and/or the moving of the second pin choke assembly from the second position to the first position when the control system determines that the food product approaches the second pin choke assembly thereby permitting the food product to pass below the second pin choke assembly. Optionally the method can include sensing, with a sensor, a leading end of the food product on the conveyor, the moving of the first pin choke assembly from the second position to the first position when the control system determines that the leading end of the food product approaches the first pin choke assembly thereby permitting the food product to pass below the first pin choke assembly, wherein the moving of the second pin choke assembly from the second position to the first position occurs when the control system determines that the leading end of the food product approaches the first pin choke assembly thereby permitting the food product to pass below the first pin choke assembly, sensing, with the sensor, a trailing end of the food product on the conveyor, moving of the first pin choke assembly from the first position to the second position when the control system determines that the trailing end of the food product clears the first pin choke assembly to thereby prevent microwaves from leaking from the module, and/or moving of the second pin choke assembly from the first position to the second position when the control system determines that the trailing end of the food product clears the second pin choke assembly to thereby prevent microwaves from leaking from the module.

Various other features, objects, and advantages will be made apparent from the following description taken together with the drawings.

### BRIEF DESCRIPTION OF THE DRAWINGS

The present disclosure is described with reference to the following Figures. The same numbers are used throughout the Figures to reference like features and like components.

FIG. 1 is a partial perspective view of an example food processing system according to the present disclosure.

FIG. 2 is a partial perspective view of an example microwave suppression system of the present disclosure.

FIG. 3 is a cross-sectional view of an example microwave suppression system of FIG. 2 with a pin choke assembly in a first position.

FIG. 4 is a cross-sectional view of an example microwave suppression system of FIG. 2 with a pin choke assembly in a second position.

FIG. 5 is a schematic diagram of an example control system of the present disclosure.

FIG. 6 is a partial perspective view of another example food processing system according to the present disclosure.

FIG. 7 is a partial perspective view of an example microwave suppression system of the present disclosure.

FIG. 8 is a cross-sectional view of an example microwave suppression system of FIG. 7 with a pin choke assemblies in first positions.

FIG. 9 is a view like FIG. 8 with the pin choke assemblies in second positions.

FIG. 10 is a view like FIG. 8 with the first pin choke assembly in the second position and the second pin choke assembly in the first position.

FIG. 11 is a view like FIG. 8 with the first pin choke assembly in the first position and the second pin choke assembly in the second position.

FIG. 12 is a schematic diagram of an example method according to the present disclosure.

### DETAILED DESCRIPTION

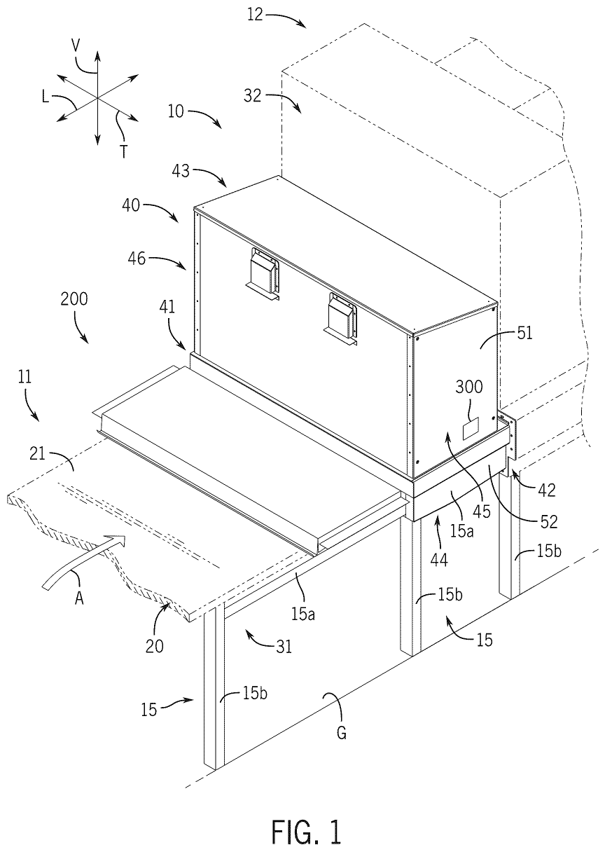

FIG. 1 partially depicts an example food processing machine or system 10, e.g., oven, according to the present disclosure. The system 10 has an upstream first end 11 configured to receive food products (e.g., bacon, hamburgers, potato chips, snack foods) and an opposite downstream second end 12 that dispenses the cooked and/or heated food products. Note that the location of the second end 12 is schematically depicted by part number 12 in FIG. 1 as FIG. 1 depicts a partial view of the example system 10. An example food processing module 32 is partially depicted in dashed lines and coupled to an example microwave control module 40 (described herein below).

Generally, the system 10 includes one or more modules positioned between the ends 11, 12 with a conveyor 20 extending between the ends 11, 12. The conveyor 20 is configured to convey the food products (not depicted) from the first end 11 through the various modules and to the second end 12. The conveyor 20 conveys the food products in the downstream direction which is depicted by arrow A. In certain examples, the conveyor 20 is an endless belt conveyor with a belt 21 on which the food products are placed. The belt 21 can be formed with metallic materials. Note that in other examples the conveyor 20 includes other components such as chains, plates, hooks, troughs, non-metallic belts, and/or the like.

The system 10 can include several modules, systems, or sections, and in one example the system 10 includes (stated in order from the first end 11 to the second end 12) an infeed section 31, microwave suppression system 200, a microwave control module 40, a food processing module 32, and an outfeed module (not depicted). The infeed section 31 is configured to receive the food products from an upstream infeed equipment or machine (not depicted). In certain examples, the infeed section 31 includes components such as enclosure panels, knives, guide members for positioning the food product on the conveyor 20, and/or the like. The microwave control module 40 is configured to generate microwaves and apply the microwaves in a controlled and uniform distribution to the food products as the conveyor 20 as the food products are conveyed through the microwave control module 40. The food processing module 32 is configured to process (e.g., heat, cook, sear, cool) the food products as the food products are conveyed there through. The outfeed section (not depicted) dispenses the processed food product to the operator or another machine or system (not depicted; e.g., a packaging system configured to package the processed food products). Reference is made to above-incorporated U.S. Pat. No. 11,412,584 and U.S. Patent Application Publication No. 2022/0346198 which describe other food processing systems, sections, machines, ovens, modules, features, and/or components that can be utilized with the example food processing systems 10 described herein.

In the example depicted in FIG. 1, the microwave control module 40 is upstream of the food processing module 32. The microwave control module 40 generally extends along a longitudinal axis (see axis L on FIG. 1) between an upstream first module end 41 and an opposite downstream second module end 42, a vertical axis (see axis V on FIG. 1) between a top 43 and an opposite bottom 44, and a transverse axis (see axis T on FIG. 1) between a first side 45 and a second side 46. The microwave control module 40 includes a first enclosure (not depicted) in which waveguide assemblies (not depicted) are located and a second enclosure (not depicted) vertically below the first enclosure that at least partially surrounds the belt 21. The second module end 42 is coupled to and/or abuts the downstream food processing module 32 to prevent or minimize microwaves leaking from between the modules 32, 40. In other examples, the microwave control module 40 is spaced apart from the food processing module 32. The microwave control module 40 is vertically supported by a frame 15 which is schematically depicted with longitudinally extending beams 15a and vertically extending posts 15b that contact the ground G.

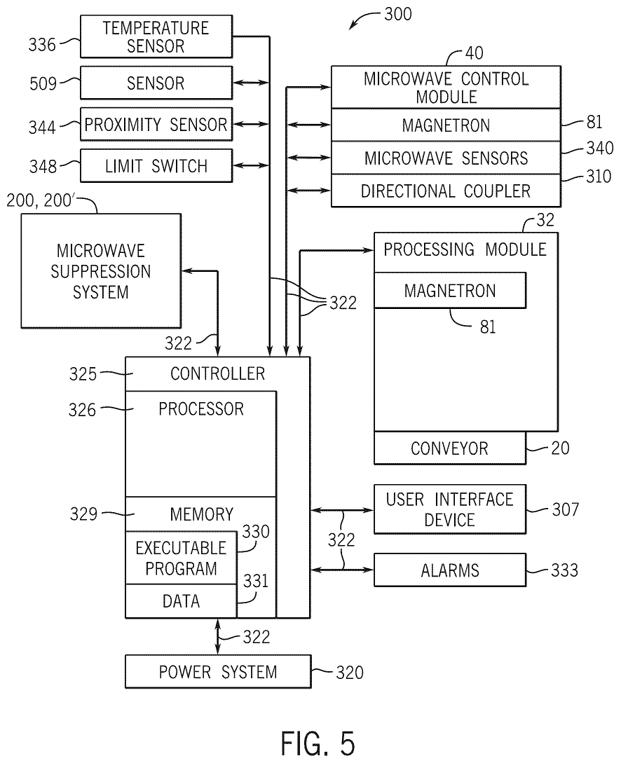

In certain examples, the food processing module 32 and/or the microwave control module 40 utilizes the microwave to process the food products. For example, the module 32, 40 emits microwave energy in the chamber such that the microwave energy processes (e.g., heats) the food products. The modules 32, 40 can include one or more waveguide assemblies for directing microwaves from a magnetrons 81 (FIG. 5) which is configured to generate microwaves. A magnetron head assembly can include other components (e.g., transformer, capacitor, cooling fan/blower). An example of the magnetron head assembly with a magnetron 81 is a 2450.0 MHZ open frame magnetron head assembly commercially available from MKS (part numbers TXO and TXA). Power supply units supply electrical power to the magnetron head assembly 84. Note that in other examples, the magnetrons are configured to emit microwave energy at other frequencies, such as 915.0 MHZ.

The waveguide assembly has a first end coupled to and configured to receive the microwave energy from the magnetron head assembly and/or magnetron 81. The waveguide assembly also has an opposite second end through which the microwave energy passes toward the conveyor 20. In certain examples, the waveguide assembly is configured to transform microwave energy into polarized, spinning microwave energy and guide the microwave energy onto belt 21 and food products thereon. Reference is made to the example waveguide assemblies described in above-incorporated U.S. Patent Application Publication No. 2022/0346198 which features and components that may be utilized with the waveguide assemblies of the present disclosure.

A microwave suppression system 200 is located upstream of the microwave control module 40. In certain examples, the microwave suppression system 200 coupled to the microwave control module 40. In other examples, the microwave suppression system 200 is part of the microwave control module 40. The microwave suppression system 200 is for preventing microwaves from leaking from the system 10 and is preferably located adjacent to or integrally combined with a module in which microwave energy is emitted and/or utilized.

The present inventors recognized that microwave energy leaking from the system 10 can be harmful to workers working near the system 10 and that in some jurisdictions, governmental rules and standards dictate the maximum amount of microwave energy that can leak from equipment Accordingly, the present inventors developed the microwave suppression systems 200 (and components and assemblies thereof) of the present disclosure to reduce or eliminate the amount of leaking microwave energy that may otherwise leak or emit from the system 10.

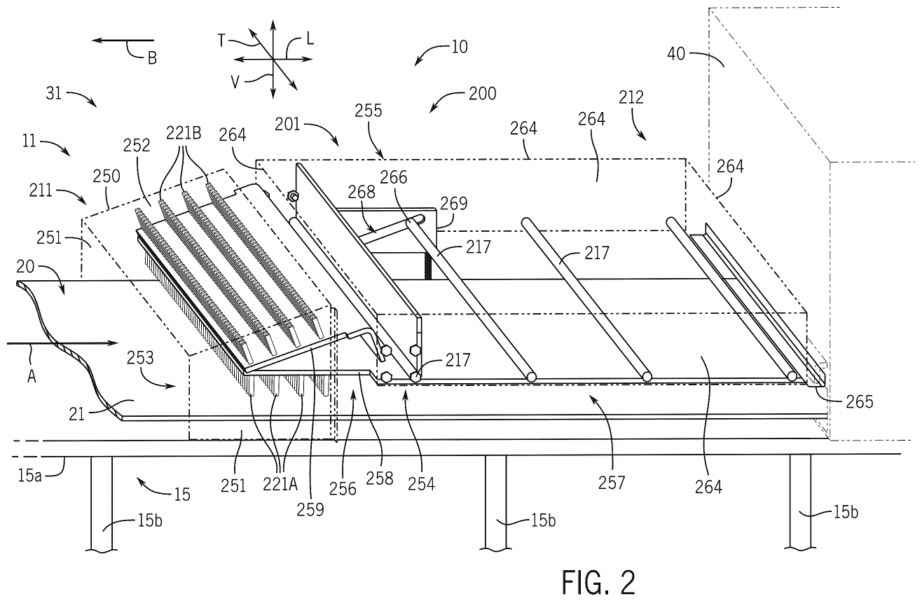

The example systems 10, sub-systems, components, and/or features depicted in FIGS. 2-11 and described herein below can include one or more features and/or components described with reference to the system 10 described above and depicted with respect to FIG. 1. Similarly, the systems 10, sub-systems, components, and/or features described with reference to FIG. 1 can include any features and/or components described herein below with reference to FIGS. 2-11. Note that components of the example systems 10 described with reference to FIGS. 2-11 that are similar to the components of the example system 10 described with reference to FIG. 1 are denoted with the same part numbers, however, it should be understood that the use of the same part numbers for systems and/or components of the present disclosure should not be construed to indicate that the similarly marked systems and/or components are necessarily identical. Instead, the similarly marked systems and/or components may have varying features or characteristics. For instance, the size and shape of the microwave suppression system 200 FIG. 1 may be different than the microwave suppression system 200 of FIG. 2.

Referring to FIGS. 2-4, another example microwave suppression system 200 of the present disclosure is depicted in greater detail. The microwave suppression system 200 can be coupled to and/or adjacent to the food processing module 32 (FIG. 1) or the microwave control module 40 (depicted in dashed lines in FIG. 2).

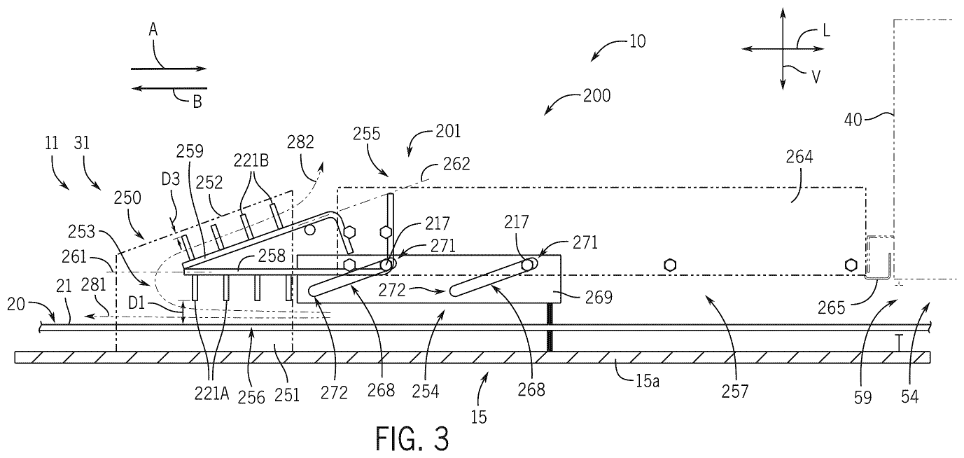

The microwave suppression system 200 includes a tunnel 201 that is configured to suppress and/or absorb microwave energy that passes through an opening 59 (FIG. 3) of the microwave control module 40. The opening 59 is in communication with the interior space 54 (FIG. 3) of the microwave control module 40. In the example depicted in FIGS. 2-4, the tunnel 201 is positioned upstream of the microwave control module 40. Note that in other examples, the tunnel 201 is positioned next to any another module or section of the system 10 (e.g., the food processing module 32 of FIG. 1). In certain examples, the microwave suppression system 200 is provided with the infeed section 31. In other examples, the microwave suppression system 200 is provided between the microwave control module 40 and the food processing module 32. In other examples, the microwave suppression system 200 is provided upstream and/or downstream of the microwave control module 40 and/or the food processing module 32.

The present inventors have recognized that the size and shape of the food products processed by the system 10 can vary. For example, certain food products extend a small depth or height off the belt 21 (e.g., 0.25″ thick strips of bacon) while other food products extend a large depth or height off the belt 21 (e.g., 1.0″ thick chicken breasts). The food products must freely pass through the system 10 by way of the conveyor 20, and the microwave suppression devices (e.g., pin chokes 221) should not obstruct movement of the food products. It may also be a requirement to position the microwave suppression devices a predetermined distance from the conveyor 20 to thereby minimize and/or eliminate microwave leaking from the modules 32, 40 and/or the tunnels 201. The present inventors have observed that some conventional systems require the operators of these conventional systems to disassemble the tunnel or shut down the system for periods of time to install different microwave suppression devices and/or change the position of the microwave suppression devices such that new food products having a new depth or height can be processed in the conventional system. For example, an operator removes 1.0 inch height pin chokes and installs new 0.5 inch height pin chokes). This process can be a time-consuming and costly.

As such, the present inventors have developed the new example microwave suppression systems 200 of the present disclosure that have movable components that allow the operator to quickly and efficiently change the clearance distance between the belt 21 and the microwave suppression devices without replacing components of the tunnel and/or shutting the system down for extended periods of time. Example microwave suppression systems 200 are further described herein below in more detail.

The tunnel 201 has a first tunnel end 211 and an opposite second tunnel end 212. The tunnel 201 includes a hood 250 (depicted in dashed lines) that is fixedly coupled to the frame 15 and remains stationary. The hood 250 includes a pair of side panels 251 (depicted in dashed lines) and an upper plate 252 (depicted in dashed lines). As such, the hood 250 at least partially defines a first passageway 253 therethrough. In certain examples, the hood 250 includes a lower plate (not depicted) opposite the upper plate 252 that is coupled to the frame 15. In these examples, the hood 250 encircles the first passageway 253 and the belt 21. In certain examples, the upper plate 252 is vertically upwardly sloped in the downstream direction (see arrow A).

A movable pin choke assembly 255 includes a first body section 256 that extends into the first passageway 253 and a second body section 257 that at least partially defines a second passageway 254 of the tunnel 201. The second passageway 254 is located between the second body section 257 and the belt 21. Optionally, a cover (not depicted) is located around the movable pin choke assembly 255 and is configured to prevent debris from reaching the movable pin choke assembly 255 and the belt 25 and further contain any microwaves. The first body section 256 and the second body section 257 are coupled to each other, and the first body section 256 is cantilevered from the second body section 257 into the first passageway 253.

The first body section 256 includes a laterally extending first plate 258 that extends in a first plane 261 (e.g., horizontal plane, a plane that is generally parallel to the plane along which the belt 21 extends). A first plurality of pin chokes 221A extend away from the first plate 258 toward the belt 21. The first plurality of pin chokes 221A are spaced apart from each other and arranged in rows on the first plate 258.

The first body section 256 also includes a laterally extending second plate 259 that extends in a second plane 262 that is transverse to the first plane 261. As such, the first plate 258 and the second plate 259 define an angle therebetween. In certain examples, the second plane 262 extends parallel with the upper plate 252 of the hood 250. A second plurality of pin chokes 221B extend away from the second plate 259 toward the upper plate 252. The second plurality of pin chokes 221B are spaced apart from each other and arranged in rows on the second plate 259. The second plurality of pin chokes 221B extend away from the second plate 259 toward the upper plate of the hood 250. Note that a small gap (see distance D3 in FIG. 3) is defined between the second plurality of pin chokes 221B and the hood 250. The pin chokes 221A, 221B are configured to act microwave chokes that prevents the propagation of microwaves thereby.

The second body section 257 includes a plurality of wall 264 (depicted in dashed lines), a flange 265 at the second tunnel end 212, and one or more rods 217 that laterally extend between the walls 264. A bracket 269 (FIG. 3) is fixedly coupled to the frame 15, and the bracket 269 defines a slot 268 in which a rod end 266 of the one of the rods 217 is received. Note that FIGS. 2-4 depict only one bracket 269 of the second body section 257 which is located on one lateral side of the belt 21, and in other examples, the second body section 257 includes a second bracket (not depicted) located on the other lateral side of the belt 21 such that the other rod end 266 of the rod 217 is received in a slot of the second bracket 269. Note that rod ends 266 can be referred to generally as guide members.

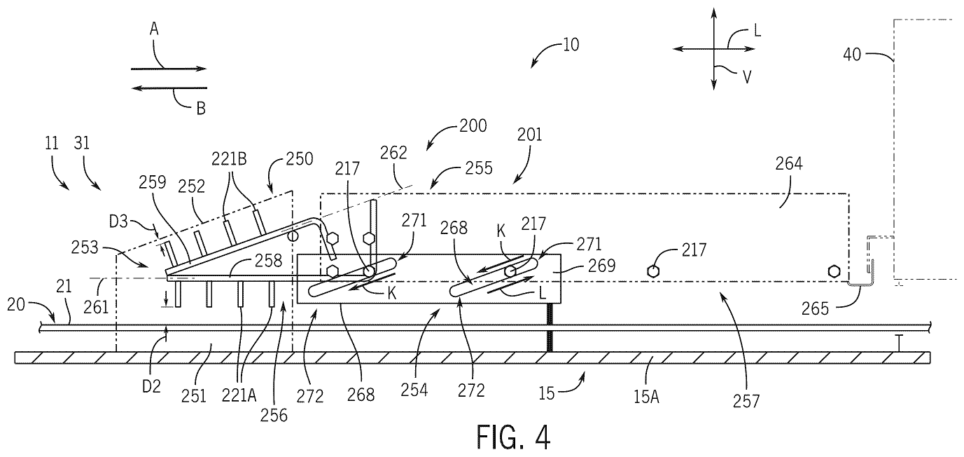

The slot 268 is vertically downwardly sloped in the upstream direction (arrow B), and the slot 268 includes a first slot end 271 that is vertically above an opposite second slot end 272. The slot 268 is configured to guide movement of the movable pin choke assembly 255 into and between different positions (described hereinbelow). The example bracket 269 depicted in FIGS. 3-4 includes two slots 268 and a rod end 266 of two separate rods 217 are received. In other examples, the bracket 269 includes one or more than two slots 268.

Operation and/or movement of the movable pin choke assembly 255 is described below and with reference to FIGS. 3-4. FIG. 3 depicts the movable pin choke assembly 255 a first position such that the first plurality of pin chokes 221A are spaced apart from belt 21 by a first clearance distance D1 is 1.5 inches. The rod ends 266 in respective slots 268 are near the first slot end 271. With the first plurality of pin chokes 221A located the first clearance distance D1 away from the belt 21, food products with relatively large depths/heights can be conveyed by the conveyor 20 the tunnel 201 without the first plurality of pin chokes 221A obstructing and/or contacting food products. In one example, the first clearance distance D1 is 1.5 inches. The plurality of pin chokes 221A, prevent or reduce microwave leakage from the tunnel 201 that propagate along a first path 281 through the passageways 253, 254.

In the event that the distance between the belt 21 and the first plurality of pin chokes 221A must be reduced due to relatively thinner food products (which absorb relatively less amounts of microwaves) are conveyed by on the belt 21, the movable pin choke assembly 255 can be moved (either manually or by an actuator) into a second position (FIG. 4) to thereby accommodate the food products and continue to prevent leakage of microwaves from the tunnel 201. For example, the first plurality of pin chokes 221A may need to be moved closer to the belt 21 to thereby prevent microwaves from leaking from the tunnel 201 The movable features of the movable pin choke assembly 255 and/or the pin chokes 221A allows for different food products and/or food products with different dimensions to be processed by the system 10.

The movable pin choke assembly 255 is moved into and between the first position (FIG. 3) to the second position (FIG. 4) manually or by an actuator (e.g., piston cylinder). In one example, the operator applies a force to the movable pin choke assembly 255 in an upstream direction (arrow A) and/or a vertically downward direction such that the rod end 266 slides in a first slide direction (arrow K) away from the first slot end 271 toward the second slot end 272 (see arrow K on FIG. 4). As such, the movable pin choke assembly 255 is moved in the first slide direction (arrow K) and the first plurality of pin chokes 221A are moved toward belt 21. In the second position, the first plurality of pin chokes 221A are a second clearance distance D2 away from the belt 21. The second clearance distance D2 is less than the first clearance distance D1. In one example, the second clearance distance D2 is 1.0 inches. Note that the movable pin choke assembly 255 could be further slid in the first slide direction (arrow K) until a desired third clearance distance (not depicted) is defined.

To move the movable pin choke assembly 255 from the second position (FIG. 4) to the first position (FIG. 3), the operator applies a force to the movable pin choke assembly 255 in a downstream direction (arrow A) and/or a vertically upward direction such that the rod ends 266 slide in a second slide direction (arrow L on FIG. 4) and the movable pin choke assembly 255 is moved toward the first position. Note that the first slot end 271 acts as a movement stop and when the rod end 266 are at the first slot end 271 the first plurality of pin chokes 221A is at a maximum clearance distance from the belt 21. Similarly, the second slot end 272 acts as a movement stop and when the rod end 266 are at the second slot end 272 the first plurality of pins chokes 221A is at a minimum clearance distance from the belt 21. Note that the specific direction of applied forces and/or movement of the pin choke assembly 255 may vary based on the location of the microwave suppression system 200 relative to other modules or sections of the system 10 (e.g., directions of movement and/or applied forces may be opposite the example described above when the microwave suppression system 200 positioned on the downstream side of the processing module 32).

In certain examples, a locking device (not depicted) selectively locks the position of the movable pin choke assembly 255 such that the movable pin choke assembly 255 does not inadvertently move into an undesired position. Note that the flange 265 at the second tunnel end 212 is configured to overlap and/or engage with a corresponding flange of the module 40 during movement of the movable pin choke assembly 255 such that microwaves do not leak from the second tunnel end 212 of the tunnel 201.

Note that the second plurality of pin chokes 221B are positioned an upper distance D3 away from the upper plate 252, and the second plurality of pin chokes 221B prevent or reduce microwave leakage from the tunnel 201 that propagate along a second path 282 along. In certain examples, as the movable pin choke assembly 255 is moved into and between various positions the upper distance D3 between the second plurality of pin chokes 221B and the upper plate 252 remains constant. In these examples, the width of the gap between the hood 250 and the second plurality of pin chokes 221B remains constant as the movable pin choke assembly 255 is moved into and between the first position (FIG. 3), the second position (FIG. 4), and/or a third position (not depicted).

Referring now to FIG. 5, an example control system 300 of the system 10 (FIG. 1) is depicted. The control system 300 is for controlling the operation of the system 10 and the various components, systems, and features noted above and described below. The control system 300 can include various components, modules, and/or subsystems, some of which are described herein below. In the example depicted in FIG. 5, the control system 300 includes a controller 325 that controls the system 10. In one specific example, the controller 325 is a programmable logic controller (PLC).

The controller 325 receives power from a power system 320, which in certain examples includes an electrical connection to the power systems of the facility or building in which the system 10 is assembled, batteries, and/or other energy storage systems known in the art. The power system 320 can also provide power to other components of the system 10.

The controller 325 includes a processor 326, which may be implemented as a microprocessor or the circuitry, or be disturbed across multiple processing devices or sub-systems that cooperate to execute an executable program 330 from a memory 329. Note that the example depicted in FIG. 5 includes one controller 325 in association with other components of the system 10. However, other configurations of the control system 300 are possible including configurations having multiple controllers or sub-controllers. Note that the controller 325 can be located anywhere on the system 10.

The memory 329 can include any storage media readable by the processor 326 and capable of storing the executable program 330 and/or data 331. The memory 329 may be implemented as a single storage device, or be distributed across multiple storage devices or sub-systems that cooperate to store computer readable instructions, data structures, program modules, or other data.

Peripheral devices, such as user interface devices 307, and output devices such as alarms 333 (e.g., audible alarms, visual light alarms), are in communication with the controller 325 (described further herein). In practice, the processor 326 loads and executes an executable program 330 from the memory 329, accesses data 331 stored within the memory 329, and directs the system 10 to operate.

The control system 300 communicates with the systems and/or components of the system 10 via communication links 322, which can be any wired or wireless links. The illustrated communication links 322 between functional and logical block components are merely exemplary, which may be direct or indirect, and may follow alternate pathways. In one example, the communication link 322 is a controller area network (CAN) bus; however, other types of links could be used.

The control system 300 communicates with the user interface device 307 that is configured to receive input data from the operator and/or a remote device via a network (not depicted). The user interface device 307 is also capable of displaying data and other information (e.g., maintenance alerts) to the operator. The user interface device 307 can be any suitable device such as a touch screen or a peripheral computer. The control system 300 also communicates and/or receives data from the various systems as described in further detail below. Furthermore, other systems of the system 10 or components related to the system 10 are in communication with the controller 325, such as the food processing module 32, the microwave control module 40, and the microwave suppression system 200, and components thereof (e.g., sensors). Note that while some of the components described herein below are depicted in FIG. 5 as part of various systems, the components can be independent of the systems or part of different systems.

In certain examples, the microwave generating device (e.g., magnetron 81) is in communication with the control system 300 such that operation of the microwave generating device and thereby the microwave energy generated can be controlled (described further herein). The microwave control module 40 can include microwave sensors 340 configured to sense microwave energy propagating through the waveguide assemblies. The microwave sensors 340 provide microwave data to the control system 300 that corresponds to the amount of microwave energy within the food processing module 32 or the microwave control module 40. The control system 300 can process the microwave data and/or provide control signals to the microwave generating device to thereby adjust microwave energy emitted into the interior space 54 (FIG. 3). In certain examples, a bi-directional or directional coupler 310 is in communication with the control system 300, and the coupler 310 also provides microwave data to the control system 300. In certain examples, the microwave sensor(s) 340 and the coupler 310 can be independent from modules 32, 40. In certain examples, microwave sensors 340 can be configured to sense microwaves outside of the microwave suppression system 200 and communicate signals to the control system 200 which may take action (e.g., the control system 200 may alert the operator that microwaves are leaking for the system 10 or turn off the microwave generating devices).

The system 10 can include one or more sensors, such as inductive or proximity sensors 344, for sensing presence of any module or section 31, 32, 40 and/or the microwave suppression system 200. When the proximity sensors 344 sense the presence of the microwave suppression system 200 in an operating position, the proximity sensors 344 send proximity signals or data to the control system 300 that corresponds to the presence of the microwave suppression system 200 and thus the presence of the corresponding tunnels 201. Accordingly, the control system 300 determines that the microwave generating devices can be operated because the microwave suppression system 200 is present and can therefore absorb microwave energy that may leak from the module 40. If however, the proximity sensors 344 do not sense the presence of the microwave suppression system 200 or a cover (not depicted) of the microwave suppression system 200 not in the operating position, the proximity sensors 344 do not send proximity data to the control system 300 and the control system 300 determines that the microwave suppression system 200 is not properly positioned. Therefore, the control system 300 prevents the microwave generating devices from generating microwave energy to protect the operator from being exposed to potentially harmful microwave energy. Note that in certain examples, the proximity sensors 344 are substituted with limit switches 348 that are configured to determine presence of the microwave suppression system 200 and generate the proximity data noted above.

In certain examples, the user interface device 307 receives input data from the operator. The inputs received may be related to specific operations of the system 10 and/or components thereof. For example, the operator may input data corresponding to a desired temperature within the system 10. The control system 300 processes the data and controls modules 32, 40 to thereby adjust the temperature within the system 10. The temperature sensors 336 can provide feedback signals to the control system 300 such that that control system 300 further controls the modules 32, 40. In other examples, the operator inputs data corresponding to a desired belt speed. Accordingly, the control system 300 processes the data and controls the conveyor 20 accordingly.

The operator can enter a recipe into the control system 300 via the user interface device 307. The recipe includes cooking input data for processing the food product conveyed through the system 10. Operating the system 10 according to the recipe will result in the food products being cooked to a desired specification. The recipe can include input data corresponding to cooking time, belt speed, fan or blower speed, temperature within the food processing module 32 (FIG. 1), humidity within the food processing module 32, microwave energy power level for the microwave control module 40, and the like.

The recipe can also be pre-saved onto the memory 329 such that an operator simply selects a recipe via the user interface device 307. Note that other inputs related to operation of specific components of the system 10 and/or the recipe itself can be transmitted to the controller 325 over a network (not depicted) from a remote computer, cellular phone, control panel, and/or terminal. Further note that one or more recipes can be stored on the memory 329 such that the operator can select the desired recipe. In certain examples, the recipe includes cooking data for operating multiple food processing modules 32 and/or microwave control modules 40. In certain examples, a single recipe is used for controlling each module 32, 40. In other examples, the recipe includes different cooking data for each module 32, 40.

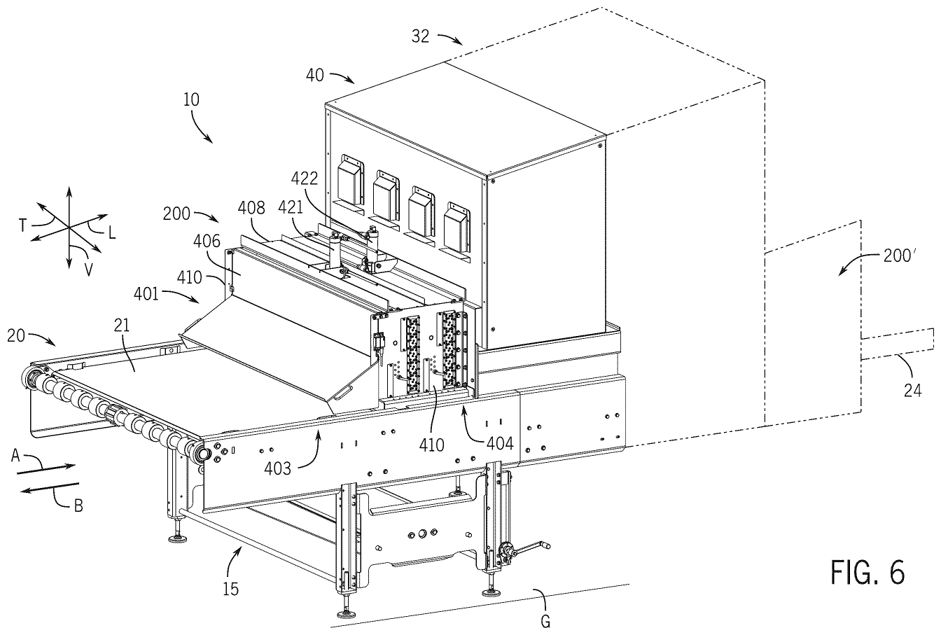

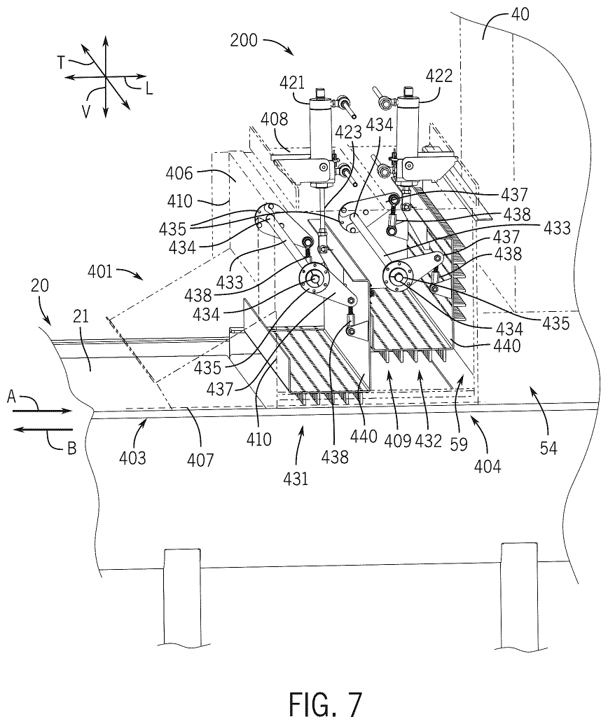

Referring now to FIGS. 6-11 another example microwave suppression system 200 is depicted. The microwave suppression system 200 includes a tunnel 401 that suppresses and/or absorbs microwave energy that passes through the opening 59 (FIG. 7) of the microwave control module 40 that leads to the interior space 54 (FIG. 7) of the microwave control module 40. Note that FIG. 6 depicts a second microwave suppression system 200′ which may be optionally included downstream of the food processing module 32. The second microwave suppression system 200′ can include any of the components and/or features of the first microwave suppression system 200 described herein below with respect to FIGS. 7-11.

The microwave suppression system 40 includes a tunnel 401 configured to suppress and/or absorb microwave energy that passes through the opening 59 (FIG. 7) of the microwave control module 40. The opening 59 is in communication with the interior space 54 (FIG. 7) of the microwave control module 40.

The tunnel 401 has a first tunnel end 403 and an opposite second tunnel end 404. The tunnel 401 defines a passageway 407 through which food products are conveyed on the belt 21 of the conveyor 20.

The tunnel 201 includes a hood 405 and an enclosure 406 that are coupled to the frame 15. The enclosure 406 is coupled to and/or adjacent to the control module 32. The enclosure has an upper panel 408 to which one or more actuators 421, 422 are coupled (described further herein), and the enclosure 406 at least partially defines an internal cavity 409. The enclosure 406 also includes walls 410 that define one or more slots 411 therein. In other examples, a bracket (not depicted) with the slots defined therein is coupled to the interior surface of the walls 410.

One or more pin choke assemblies 431, 432 are positioned in the cavity 409. The number of pin choke assemblies can vary, and in the example microwave suppression system 200 depicted in FIGS. 7-11, two pin choke assemblies, namely a first pin choke assembly 431 and a second pin choke assembly 432. The pin choke assemblies 431, 432 are adjacent to each other with the first pin choke assembly 431 upstream of the second pin choke assembly 432. The pin choke assemblies 431, 432 are independently movable relative to each other. Note that while the pin choke assemblies are described hereinbelow relative to the first pin choke assembly 431, the second pin choke assembly 432 can include any of the features and/or components that are described with reference to the first pin choke assembly 432.

The first pin choke assembly 431 includes a rod 433 that laterally extend through the cavity 409 and has rod ends 434 that are coupled to the walls 410 via brackets 435. The brackets 435 vertically support the rod 433 and permit the rod 433 to rotation about its laterally extending center axis 436. An arm 437 is coupled to each rod end 434, and the arms 437 are fixed to the rod 433 such that the arms 437 pivot about the axis 436. A linking device 438 (e.g., threaded rod with eyelets, pins, and/or cables) is coupled to each arm 437, and the linkage device 468 is coupled to a flange 441 of a frame 440 (described herein).

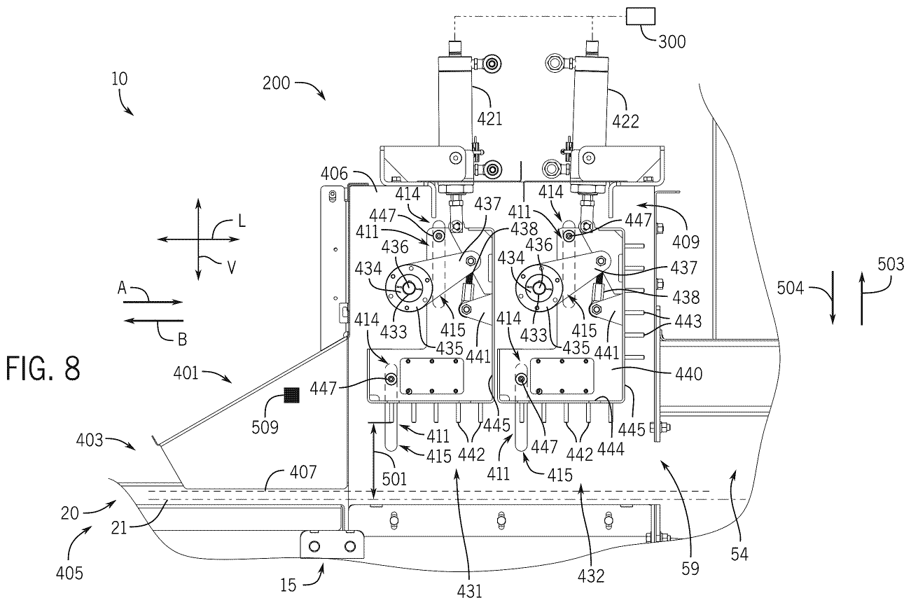

The first pin choke assembly 431 includes a frame 440 to which a first plurality of pin chokes 442 are coupled and a second plurality of pin chokes 443 are coupled. The first plurality of pin chokes 442 vertically extend away the frame 440 toward the belt 21 (the belt 21 is depicted as a dashed line in FIGS. 8-11). The first plurality of pin chokes 442 are spaced apart from each other and arranged in rows on a first frame section 444 of the frame 440. The plurality of pin chokes 442, 443, act as microwave chokes to prevent or reduce microwave leakage from the food processing module 32 that propagates away from the food processing module 32 toward and into the food suppression system 200.

Note that the second pin choke assembly 432 includes the first plurality of pin chokes 442 and a second plurality of pin chokes 443. The second plurality of pin chokes 443 are located on a second frame section 445 of the frame 440, and the second plurality of pin chokes 443 extend from the frame 440 in a different direction than the first plurality of pin chokes 442. In the example depicted in FIGS. 8-11, the second plurality of pin chokes 443 longitudinal extend away the frame 440 in the downstream direction (arrow A). In certain examples, the second plurality of pin chokes 443 extend at an angle relative to the downstream direction (e.g., the second plurality of pin chokes 443 extend at a 30.0 degree angle relative to the downstream direction and toward the belt 21).

The second plurality of pin chokes 443 orientated transverse to the first plurality of pin chokes 442. In certain examples, the second plurality of pin chokes 443 extend perpendicular to the first plurality of pin chokes 442. In certain examples, the second plurality of pin chokes 443 and the first plurality of pin chokes 442 extend relative to each other and define an acute or obtuse angle therebetween.

One or more guide members, such as a pin 447 or a flange, are coupled to the frame 440 and laterally extend therefrom. The pin 447 are received in the slots 411. Note that number of pins 447 and the slots 411 can vary from the number of pins 447 and the slots 411 depicted on FIGS. 8-11. Also note that while FIGS. 8-11 depict the pins 447 engaging slots 411 defined in one of the wall 410, in certain other examples, additional pins 447 may engage slots 411 defined in the opposite wall 410. Each slot 411 has an upper first slot end 414 and an opposite lower second slot end 415. Note that the pins 447 can be referred to as guide members.

The flange 441 of the frame 440 is coupled to the linking device 438 such that the linking device 438 pivots (about one or more axes) relative to the frame 440. The frame is also coupled to the first actuator 421. For example, the first actuator 421 includes a pneumatic cylinder with a piston that couples to the frame 440.

FIGS. 8-11 depicts the pin choke assemblies 431, 432 in different positions. Example operations and/or movement of different components of the microwave suppression system 200 are described herein below.

FIG. 8 depicts the first pin choke assembly 431 and the second pin choke assembly 432 each in a first position. In the first position, the first plurality of pin chokes 442 are located a first or maximum clearance distance 501 away from the belt 21. In certain examples, the first clearance distance 501 is 3.5 inches. With the first plurality of pin chokes 442 located the first clearance distance 501 away from the belt 21, food products with relatively large depths/heights can be conveyed by the conveyor 20 the tunnel 401 without the first plurality of pin chokes 442 obstructing and/or contacting food products.

The pins 447 are at or near the first slot ends 414. Note that the pins 447 may contact the wall 410 when at the first slot end 414 thereby stopping or preventing movement of the pins 447 and the frame 440 in a first direction 503 and further preventing the first plurality of pins 442 from exceeding the first clearance distance 501. Each pin choke assembly 431 is held in the first position by the actuators 421, 422, respectively.

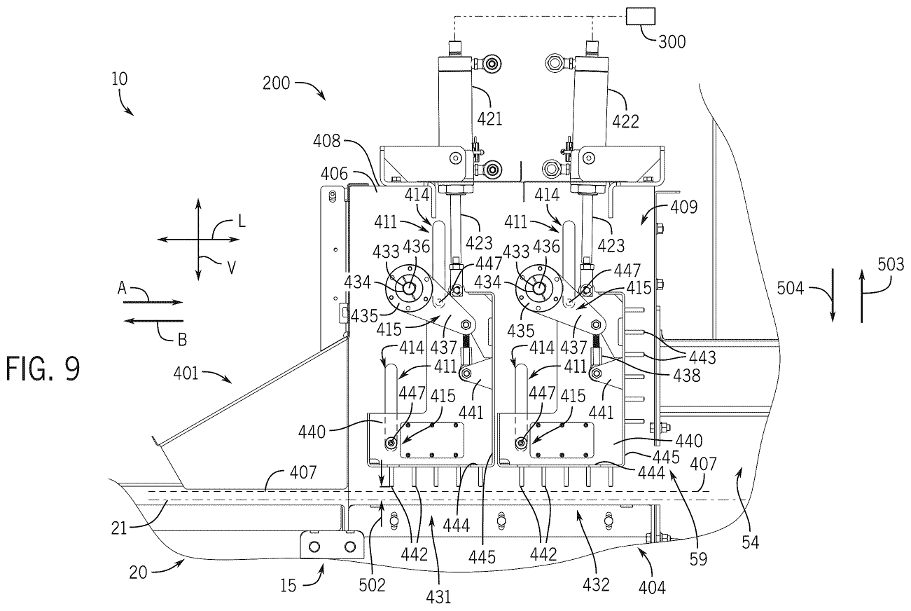

Referring to FIG. 9, the first pin choke assembly 431 and the second pin choke assembly 432 are depicted moved from the first position (FIG. 8) into the second position (FIG. 9). In the second position, the first plurality of pin chokes 442 are located a second clearance distance 502 away from the belt 21. In certain examples, the second or minimum clearance distance 502 is 0.5 inches. With the first plurality of pin chokes 442 located the second clearance distance 502 away from the belt 21, food products with relatively thinner depths/heights can be conveyed by the conveyor 20 the tunnel 401 without the first plurality of pin chokes 442 obstructing and/or contacting food products.

The pins 447 are at or near the second slot ends 415. Note that the pins 447 may contact the wall 410 when at the second slot end 415 thereby stopping or preventing movement of the pins 447 and the frame 440 in a second direction 504 and further preventing the first plurality of pins 442 from moving pas the second clearance distance 502. Each pin choke assembly 431 is held in the second position by the actuators 421, 422, respectively.

To move the first pin choke assembly 431 from the first position (FIG. 8) into the second position (FIG. 9), the first actuator 421 is controlled by the control system 300 such that a driving member 423 (e.g., piston) extends into the cavity 409. The diving member 423 applies a force directed in the second direction 504 on the frame 440 such that the frame 440 is moved the second direction 504 toward the belt 21. The pins 447 are also moved in the second direction 504 in the slots 411 toward the second slot ends 415. The slots 411 vertically guide the pins 447 and the frame 440 in the second direction 504. As such, the frame 440 and the pin chokes 442 translate in the second direction 504. As the frame 440 is moved in the second direction 504, the frame 440 acts on the linking device 438 via the flange 441 which causes the linking device 438 to pivot and act on the arms 437. The arms 437 pivot about the axis 436 and thereby rotates the rod 433. The linking device 438, the arms 437, and the rod 433 cooperate together to assist in guiding the frame 440 to translate as noted above and/or prevent longitudinal movement of the frame 440.

To move the first pin choke assembly 431 from the second position (FIG. 9) into the first position (FIG. 8), the first actuator 421 is controlled by the control system 300 such that a driving member 423 (e.g., piston) retracts from the cavity 409. The diving member 423 applies a force directed in the first direction 503 on the frame 440 such that the frame 440 is moved in the first direction 503 away from the belt 21. The pins 447 are also moved in the first direction 503 in the slots 411 toward the first slot ends 414. The slots 411 vertically guide the pins 447 and the frame 440 in the first direction 503. As such, the frame 440 and the pin chokes 442 translate in the first direction 503. As the frame 440 is moved in the first direction 503, the frame 440 acts on the linking device 438 via the flange 441 which causes the linking device 438 to pivot and act on the arms 437.

Note that the second pin choke assembly 432 can be moved in a similar manner from the first position and the second position and from the second position to the first position as described above with respect to the first pin choke assembly 432. The second pin choke assembly 432 is moved by the second actuator 422, and the second plurality of pin chokes 443 are translated in the first direction 403 or the second direction 504 as the second pin choke assembly 432 is moved.

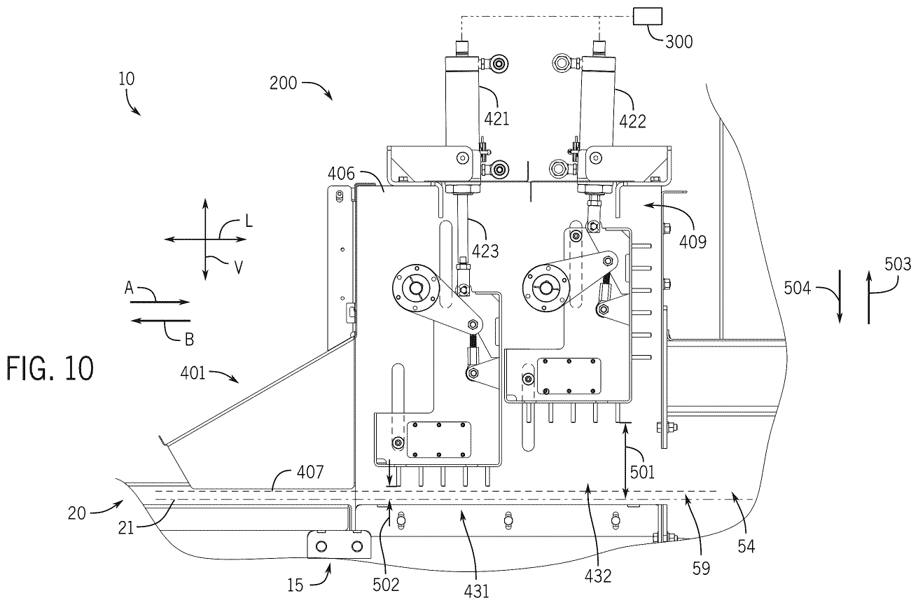

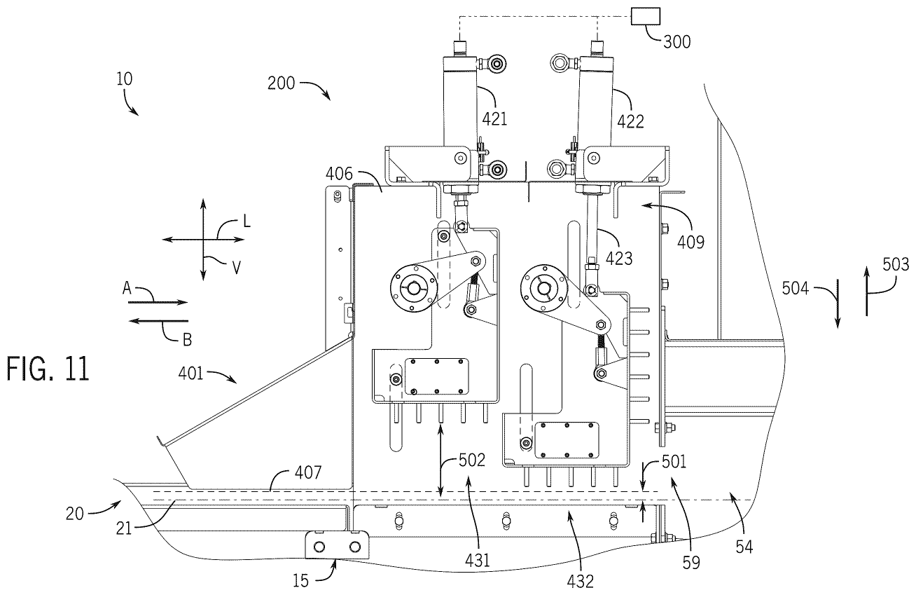

The first pin choke assembly 431 and the second pin choke assembly 432 can be moved independently of each other. For example, FIG. 10 depicts the first pin choke assembly 431 moved into the second position and the second pin choke assembly 432 moved into the first position. FIG. 11 depicts the first pin choke assembly 431 moved into the first position and the second pin choke assembly 432 moved into the second position. In certain examples, a proximity switch (not depicted) is configured to sense the actual position of the pin choke assemblies 431, 432 and send corresponding signals to the control system 300.

The present inventors recognized that moving the pin choke assemblies 431, 432 relative to each other and into and between the first positions and the second positions allows the operator of the system to accommodate different types of food products to be conveyed through the system 10 while preventing microwaves from leaking from the system 10. In addition, moving the assemblies 431, 432 relative to each other and into and between the first positions and the second positions allows the system 10 better protect against microwave leakage when the system is starting up, shutting down, and/or receiving food products with different heights.

The present inventors have also recognized that when the first food products in a series of food products begin to the conveyed through the system 10 in the downstream direction (arrow A), the food products may not be entirely in the microwave suppression system and therefore not absorbing the anticipated amount of microwaves. As such, the extra microwaves may leak from the system 10. To avoid these problems, the second pin choke assembly 432 is moved into the second position while the first pin choke assembly 432 is in the first position (FIG. 11). As such, the second pin choke assembly 432 prevents excess microwave leakage. Once the first food products in a series of food products in completely within the tunnel 401, the food products are absorbing the anticipated amount of microwaves and the control system 300 moves the second pin choke assembly 432 into the first position (FIG. 8) so that the food products can be conveyed along the system 10.

Note that a similar operational sequence may occur when the food products are conveyed in the upstream direction (arrow B) or the microwave suppression system 200 is positioned on the downstream side of a module that generates microwaves. In these examples, the first pin choke assembly 431 is moved into the second position while the second pin choke assembly 432 is in the first position (FIG. 10). As such, the first pin choke assembly 431 prevents excess microwave leakage. Once the first food products exiting the module 30, 42 is completely within the tunnel 401, the food products are absorbing the anticipated amount of microwaves and the control system 300 moves the first pin choke assembly 431 into the first position (FIG. 8) so that the food products can be conveyed further along the system 10.

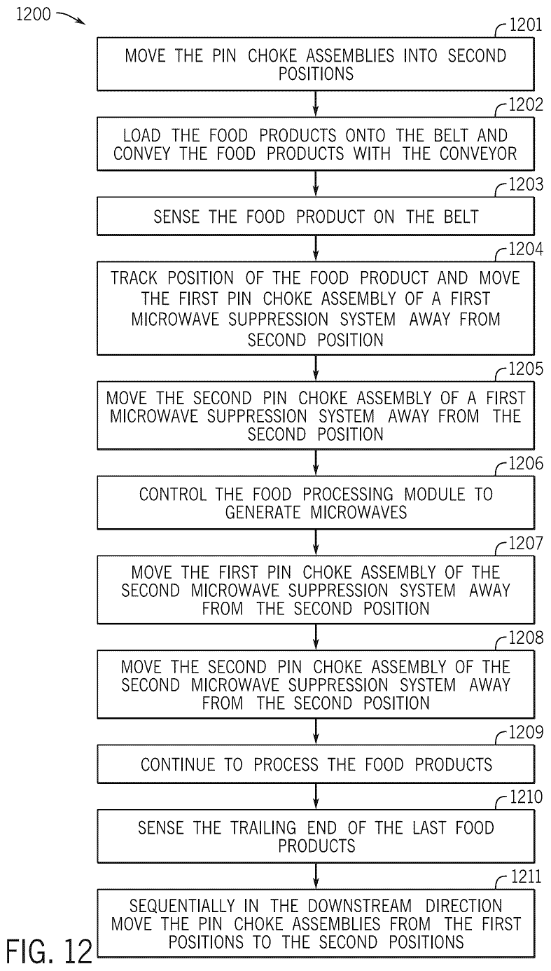

FIG. 12 depicts an example operational method 1200 for operating the system 10 and/or the microwave suppression system 200 depicted in FIGS. 8-11. Note that the method 1200 is described with reference to a food processing system 10 having a first microwave suppression system 200 upstream of the food processing module 32 and a second microwave suppression system 200′ downstream of the food processing module 32 (see for example the second microwave suppression system 200′ schematically depicted in FIG. 6). The example method 1200 is described below as a series of logic steps, the effects of which may be already discussed above with respect to one or more of the example systems described above with respect to FIGS. 1-11. The example method 1200 can include any other features and/or components discussed above with regard to different example systems 10 and/or example microwave suppression systems 200 noted above. It should be understood that example method 1200 can include other steps and/or features described in the present disclosure. Furthermore, the present disclosure contemplates other methods that can include any combination of individual or multiple steps from the example method 1200 and the present disclosure is not limited to the specific combination of steps set forth below.

The example method 1200 begins, at step 1201, with operating the first microwave suppression system 200 such that the pin choke assemblies 431, 432 are in the second positions (FIG. 9) such that the first plurality of pin chokes 442 are at the minimum clearance distance 502 from the belt 21. As such, the first plurality of pin chokes 442 of the pin choke assemblies 431, 432 absorb a large amount of microwaves.

At step 1202, the food product(s) are loaded onto the belt 21 and the conveyor 20 conveys the food products in the downstream direction (arrow A) while the modules 30, 42 do not generate microwaves.

The food products are sensed by a sensor 509 (FIG. 5; e.g., a photo eye, laser, laser that emits a diagonal laser beam) which communicates to the control system 300 that the food products are at a sensed location, at step 1203.

At step 1204, the control system 300 is configured to track the position of the food product and/or the belt 21 such that the control system 300 moves the first pin choke assembly 431 away from the second position as the leading end of the food product reaches as the first plurality of pin chokes 442 on the first pin choke assembly 431. As such, the first plurality of pin chokes 442 are moved out of the way of the food products and do not obstruct the food products. Note that the control system 300 may track the position of the food products based on data from encoders in the conveyor, sensor data, speed of the conveyor 20, distance between the sensor 509 and the pin choke assemblies 431, associated algorithms and/or the like.

At step 1205 the control system moves the second pin choke assembly 432 away from the second position as the leading end of the food product reaches the first plurality of pin chokes 442 on the second pin choke assembly 432. As such, the first plurality of pin chokes 442 are moved out of the way of the food products and do not obstruct the food products.

As the leading edge of the food product begins to exit the first microwave suppression system 200 into a downstream food processing module 40, the food processing module 40 begins to generate microwaves such that the food products are evenly processed, at step 1206. The food products are conveyed further through the food processing module 40 and reminder of the food processing system 10.

At step 1207, as the leading edge of the food products reaches the first pin choke assembly 431 of the second microwave suppression system 200′, the first pin choke assembly 431 of the second microwave suppression system 200′ is moved by another actuator from the second position toward the first position.

At step 1208, when the leading edge of the food products reach the second pin choke assembly 431 of the second microwave suppression system 200′, the second pin choke assembly 432 of the second microwave suppression system 200′ is moved by another actuator from the second position to the first position. As such, the pin choke assemblies 431, 432 of both the first microwave suppression system 200 upstream and the second microwave suppression system 200′ are in the first positions.

At step 1209, the system 10 conveys and processing the food products which are placed on the belt 21.

At step 1210, the sensor 509 does not sense any more food products and/or senses the trailing end of the last food products, the sensor 509 communicates the same and/or the position of the trailing end of the last food products to the control system 300.

At step 1211, the control system 300 is configured to track the position of the last food product such that as the last food product moves past or clears each of the first pluralities of pin chokes 442 on each of the pin choke assemblies 431, 432 of the first and second microwave suppression systems 200, 200′, the control system 300 moves the corresponding pin choke assemblies 431, 432 from the first position to the second position. For example, once the last food products clears the first plurality of pin chokes 442 on the first pin choke assembly 431 of the first microwave suppression system 200, the control system 300 controls the corresponding actuator to move the first pin choke assembly 432 to the second position. Similarly, as the last food products clears the first plurality of pin chokes 442 on the second pin choke assembly 432 of the first microwave suppression system 200, the control system 300 controls the corresponding actuator to move the second pin choke assembly 432 to the second position. The same sequence occurs as the last food products clears the first plurality of pin chokes 442 of the pin choke assemblies 431, 432 of the second microwave suppression system 200′.

Optionally, the control system 300 can be configured to cause the food processing module 40 to no longer emit microwaves once the trailing edge of the last food product exits the food processing module 40.

In certain independent examples, a food processing system for processing a food product includes a module with a microwave generating device configured to generate microwave energy to process the food product, a conveyor extending through the module and configured to convey the food product through the module, and a microwave suppression system configured to prevent leakage of the microwave energy from the food processing system. The microwave suppression system including a pin choke assembly with a plurality of pin chokes that is selectively movable relative to the conveyor to thereby vary a clearance distance between the plurality of pin chokes and the conveyor.

Optionally the pin choke assembly is located vertically above the conveyor and the pin choke assembly is vertically moveable relative to the conveyor. Optionally the conveyor is configured to convey the food product in an upstream direction or a downstream direction and the pin choke assembly is translatable along the conveyor in the upstream direction or the downstream direction. Optionally the plurality of pin chokes are a first plurality of pin chokes that extend toward the conveyor. Optionally the pin choke assembly includes a second plurality of pin chokes that extend away from the conveyor. Optionally the first plurality of pin chokes extend perpendicular to the second plurality of pin chokes. Optionally the second plurality of pin chokes extend toward the module. Optionally the microwave suppression system includes a wall with a slot defined therein and the pin choke assembly includes a guide member that extends into the slot such the slot guides movement of the guide member and thereby the pin choke assembly. Optionally the slot includes a first slot end that prevents movement of the guide member in a first direction and sets a maximum clearance distance between the plurality of pin chokes and the conveyor and the slot has a second slot end opposite the first slot end that prevents movement of the guide member in a first direction and sets a minimum clearance distance between the plurality of pin chokes and the conveyor. Optionally the microwave suppression system includes an actuator that moves the pin choke assembly. Optionally the pin choke assembly is a first pin choke assembly and the clearance distance is a first clearance distance and a second pin choke assembly is selectively movable relative to the conveyor to thereby vary a second clearance distance between the pin choke assembly and the conveyor. Optionally the second pin choke assembly is longitudinally spaced apart from the first pin choke assembly along the conveyor. Optionally the first pin choke assembly and the second pin choke assembly are independently movable relative to each other. Optionally the microwave suppression system further comprising a first actuator for moving the first pin choke assembly and a second actuator for moving the second pin choke assembly. Optionally the first pin choke assembly and the second pin choke assembly are located vertically above the conveyor and vertically moveable relative to the conveyor. Optionally the plurality of pin chokes are a first plurality of pin chokes that extend toward the conveyor and the second pin choke assembly includes a first plurality of pin chokes and a second plurality of pin chokes that extend away from the conveyor. Optionally the first plurality of pin chokes extend perpendicular to the second plurality of pin chokes. Optionally the second plurality of pin chokes extend toward the module.

In certain independent examples, a method for processing a food product in a food processing system includes processing, with a module configured to generate microwaves, the food product, conveying, with a conveyor, the food product through the module, moving a first pin choke assembly from a second position in which a second clearance distance is defined between the first pin choke assembly and the conveyor to a first position in which a first clearance distance is defined between the first pin choke assembly and the conveyor, the first clearance distance is greater than the second clearance distance, and/or moving a second pin choke assembly from a second position in which a second clearance distance is defined between the first pin choke assembly and the conveyor to a first position in which a first clearance distance is defined between the first pin choke assembly and the conveyor, the first clearance distance is greater than the second clearance distance.

Optionally the method can include sensing, with a sensor, a food product on a conveyor, the moving of the first pin choke assembly from the second position to the first position when the control system determines that the food product approaches the first pin choke assembly thereby permitting the food product to pass below the first pin choke assembly, and/or the moving of the second pin choke assembly from the second position to the first position when the control system determines that the food product approaches the second pin choke assembly thereby permitting the food product to pass below the second pin choke assembly. Optionally the method can include sensing, with a sensor, a leading end of the food product on the conveyor, the moving of the first pin choke assembly from the second position to the first position when the control system determines that the leading end of the food product approaches the first pin choke assembly thereby permitting the food product to pass below the first pin choke assembly, wherein the moving of the second pin choke assembly from the second position to the first position occurs when the control system determines that the leading end of the food product approaches the first pin choke assembly thereby permitting the food product to pass below the first pin choke assembly, sensing, with the sensor, a trailing end of the food product on the conveyor, moving of the first pin choke assembly from the first position to the second position when the control system determines that the trailing end of the food product clears the first pin choke assembly to thereby prevent microwaves from leaking from the module, and/or moving of the second pin choke assembly from the first position to the second position when the control system determines that the trailing end of the food product clears the second pin choke assembly to thereby prevent microwaves from leaking from the module.

In certain independent examples, a food processing system for processing a food product includes a module with a microwave generating device configured to generate microwave energy to process the food product, a conveyor extending through the module and configured to convey the food product through the module, and a microwave suppression system configured to prevent leakage of the microwave energy from the food processing system. The microwave suppression system includes a pin choke assembly that is selectively movable relative to the conveyor to thereby vary a clearance distance between the pin choke assembly and the conveyor.

Optionally the pin choke assembly is located vertically above the conveyor and the pin choke assembly is vertically moveable relative to the conveyor. Optionally the conveyor is configured to convey the food product in an upstream direction or a downstream direction and the pin choke assembly is translatable along the conveyor in the upstream direction or the downstream direction. Optionally the pin choke assembly includes a first plurality of pin chokes that extend toward the conveyor. Optionally the pin choke assembly includes a second plurality of pin chokes that extend away from the conveyor. Optionally the first plurality of pin chokes extend perpendicular to the second plurality of pin chokes. Optionally the second plurality of pin chokes extend toward the module. Optionally the microwave suppression system includes a wall with a slot defined therein and the pin choke assembly includes a pin or rod that extends into the slot such the slot guides movement of the pin or rod and thereby the pin choke assembly. Optionally the slot includes a first slot end that prevents movement of the pin or rod in a first direction and sets a maximum clearance distance between the pin choke assembly and the conveyor and a second slot end opposite the first slot end that prevents movement of the pin or rod in a first direction and sets a minimum clearance distance between the pin choke assembly and the conveyor. Optionally the microwave suppression system includes an actuator that moves the pin choke assembly. Optionally the pin choke assembly is a first pin choke assembly and the clearance distance is a first clearance distance and a second pin choke assembly is selectively movable relative to the conveyor to thereby vary a second clearance distance between the pin choke assembly and the conveyor and the second pin choke assembly is longitudinally spaced apart from the first pin choke assembly along the conveyor. Optionally the first pin choke assembly and the second pin choke assembly are independently movable relative to each other. Optionally the microwave suppression system includes a first actuator for moving the first pin choke assembly and a second actuator for moving the second pin choke assembly. Optionally the first pin choke assembly and the second pin choke assembly are located vertically above the conveyor and vertically moveable relative to the conveyor. Optionally the first pin choke assembly includes a first plurality of pin chokes that extend toward the conveyor and the second pin choke assembly includes a first plurality of pin chokes and a second plurality of pin chokes that extend away from the conveyor. Optionally the first plurality of pin chokes extend perpendicular to the second plurality of pin chokes. Optionally the second plurality of pin chokes extend toward the module.

In certain independent examples, a method for processing a food product in a food processing system includes processing, with a module configured to generate microwaves, the food product, conveying, with a conveyor, the food product through the module, moving a first pin choke assembly from a second position in which a second clearance distance is defined between the first pin choke assembly and the conveyor to a first position in which a first clearance distance is defined between the first pin choke assembly and the conveyor, the first clearance distance is greater than the second clearance distance, and moving a second pin choke assembly from a second position in which a second clearance distance is defined between the first pin choke assembly and the conveyor to a first position in which a first clearance distance is defined between the first pin choke assembly and the conveyor, wherein the first clearance distance is greater than the second clearance distance.

Optionally the method can include sensing, with a sensor, a food product on a conveyor, tracking, with a control system, location of the food product on the conveyor as the food product is conveyed by the conveyor, the moving of the first pin choke assembly from the second position to the first position when the control system determines that the food product approaches the first pin choke assembly thereby permitting the food product to pass below the first pin choke assembly, and/or the moving of the second pin choke assembly from the second position to the first position when the control system determines that the food product approaches the second pin choke assembly thereby permitting the food product to pass below the second pin choke assembly. Optionally the food product is one food product in a plurality of food products, the method can include: sensing, with a sensor, a leading end of the plurality of food products on the conveyor, tracking, with a control system, location of the leading end of the plurality of food products being conveyed on the conveyor, the moving of the first pin choke assembly from the second position to the first position when the control system determines that the leading end of the plurality of food products approaches the first pin choke assembly thereby permitting the food product to pass below the first pin choke assembly, the moving of the second pin choke assembly from the second position to the first position occurs when the control system determines that the leading end of the plurality of food products approaches the first pin choke assembly thereby permitting the food product to pass below the first pin choke assembly, sensing, with the sensor, a trailing end of the plurality of food products on the conveyor, tracking, with the control system, location of the trailing end of the plurality of food products being conveyed on the conveyor, moving of the first pin choke assembly from the first position to the second position when the control system determines that the trailing end of the plurality of food products clears the first pin choke assembly to thereby prevent microwaves from leaking from the module, and/or moving of the second pin choke assembly from the first position to the second position when the control system determines that the trailing end of the plurality of food products clears the second pin choke assembly to thereby prevent microwaves from leaking from the module. Optionally the first pin choke assembly and the second pin choke assembly are part of a first microwave suppression system that is located upstream of the module, a second microwave suppression system is located downstream of the module and includes a first pin choke assembly and a second pin choke assembly, and the food product is one food product in a plurality of food products, the method can include: sensing, with a sensor, a leading end of the plurality of food products on the conveyor, tracking, with a control system, location of the leading end of the plurality of food products being conveyed on the conveyor, the moving of the first pin choke assembly of the first microwave suppression system from the second position to the first position occurs when the control system determines that the leading end of the plurality of food products approaches the first pin choke assembly thereby permitting the food product to pass below the first pin choke assembly, the moving of the second pin choke assembly of the second microwave suppression system from the second position to the first position occurs when the control system determines that the leading end of the plurality of food products approaches the first pin choke assembly thereby permitting the food product to pass below the first pin choke assembly, moving the first pin choke assembly of the second microwave suppression system from the second position to the first position when the control system determines that the leading end of the plurality of food products approaches the first pin choke assembly thereby permitting the food product to pass below the first pin choke assembly, moving of the second pin choke assembly of the second microwave suppression system from the second position to the first position when the control system determines that the leading end of the plurality of food products approaches the second pin choke assembly thereby permitting the food product to pass below the second pin choke assembly, sensing, with the sensor a trailing end of the plurality of food products on the conveyor, tracking, with the control system, location of the trailing end of the plurality of food products being conveyed on the conveyor, moving of the first pin choke assembly of the first microwave suppression system from the first position to the second position when the control system determines that the trailing end of the plurality of food products clears the first pin choke assembly to thereby prevent microwaves from leaking from the module, moving of the second pin choke assembly of the first microwave suppression system from the first position to the second position when the control system determines that the trailing end of the plurality of food products clears the second pin choke assembly to thereby prevent microwaves from leaking from the module, moving of the first pin choke assembly of the second microwave suppression system from the first position to the second position when the control system determines that the trailing end of the plurality of food products clears the first pin choke assembly to thereby prevent microwaves from leaking from the module, and/or moving of the second pin choke assembly of the second microwave suppression system from the first position to the second position when the control system determines that the trailing end of the plurality of food products clears the second pin choke assembly to thereby prevent microwaves from leaking from the module.

In certain independent examples, a food processing system for processing a food product includes a module configured to generate microwave energy to thereby cook the food product, a conveyor configured to convey the food product through the module, and a pin choke assembly configured to absorb microwave energy leaking from the module to thereby reduce leakage of microwave energy from the food processing system. The pin choke assembly having a hood fixed relative to the conveyor, a body with a plurality of pin chokes coupled thereto and a rod, and a bracket defining a slot in which an end of the rod is slidably received. The slot is angled such that as the body is moved into a first direction a distance between a first plurality of pin chokes and the conveyor decreases and an opposite second direction the distance between the first plurality of pin chokes and the belt increases. A distance between a second plurality of pin chokes and the hood remains constant as the body is moved in the first direction or the second direction.

Citations to a number of references are made herein. The cited references are incorporated by reference herein in their entireties. In the event that there is an inconsistency between a definition of a term in the specification as compared to a definition of the term in a cited reference, the term should be interpreted based on the definition in the specification.

In the present description, certain terms have been used for brevity, clarity, and understanding. No unnecessary limitations are to be inferred therefrom beyond the requirement of the prior art because such terms are used for descriptive purposes and are intended to be broadly construed. The different apparatuses, systems, and method steps described herein may be used alone or in combination with other apparatuses, systems, and methods. It is to be expected that various equivalents, alternatives, and modifications are possible within the scope of the appended claims.

The functional block diagrams, operational sequences, and flow diagrams provided in the Figures are representative of exemplary architectures, environments, and methodologies for performing novel aspects of the disclosure. While, for purposes of simplicity of explanation, the methodologies included herein may be in the form of a functional diagram, operational sequence, or flow diagram, and may be described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology can alternatively be represented as a series of interrelated states or events, such as in a state diagram. Moreover, not all acts illustrated in a methodology may be required for a novel implementation.

This written description uses examples to disclose the invention and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A food processing system for processing a food product, the food processing system comprising:
a module with a microwave generating device configured to generate microwave energy to process the food product;
a conveyor extending through the module and configured to convey the food product through the module; and
a microwave suppression system configured to prevent leakage of the microwave energy from the food processing system, the microwave suppression system including a pin choke assembly with a plurality of pin chokes that is selectively movable relative to the conveyor to thereby vary a clearance distance between the plurality of pin chokes and the conveyor.

2. The food processing system according to claim 1, wherein the pin choke assembly is located vertically above the conveyor and the pin choke assembly is vertically moveable relative to the conveyor.

3. The food processing system according to claim 2, wherein the conveyor is configured to convey the food product in an upstream direction or a downstream direction, and wherein the pin choke assembly is translatable along the conveyor in the upstream direction or the downstream direction.

4. The food processing system according to claim 1, wherein the plurality of pin chokes are a first plurality of pin chokes that extend toward the conveyor.

5. The food processing system according to claim 4, wherein the pin choke assembly includes a second plurality of pin chokes that extend away from the conveyor.

6. The food processing system according to claim 5, wherein the first plurality of pin chokes extend perpendicular to the second plurality of pin chokes.

7. The food processing system according to claim 5, wherein the second plurality of pin chokes extend toward the module.

8. The food processing system according to claim 1, wherein the microwave suppression system includes a wall with a slot defined therein and the pin choke assembly includes a guide member that extends into the slot such the slot guides movement of the guide member and thereby the pin choke assembly.

9. The food processing system according to claim 8, wherein the slot includes a first slot end that prevents movement of the guide member in a first direction and sets a maximum clearance distance between the plurality of pin chokes and the conveyor; and
wherein the slot has a second slot end opposite the first slot end that prevents movement of the guide member in a first direction and sets a minimum clearance distance between the plurality of pin chokes and the conveyor.

10. The food processing system according to claim 1, wherein the microwave suppression system includes an actuator that moves the pin choke assembly.

11. The food processing system according to claim 1, wherein the pin choke assembly is a first pin choke assembly and the clearance distance is a first clearance distance; and further comprising a second pin choke assembly selectively movable relative to the conveyor to thereby vary a second clearance distance between the pin choke assembly and the conveyor; and
wherein the second pin choke assembly is longitudinally spaced apart from the first pin choke assembly along the conveyor.

12. The food processing system according to claim 11, wherein the first pin choke assembly and the second pin choke assembly are independently movable relative to each other.

13. The food processing system according to claim 12, the microwave suppression system further comprising a first actuator for moving the first pin choke assembly and a second actuator for moving the second pin choke assembly.

14. The food processing system according to claim 11, wherein the first pin choke assembly and the second pin choke assembly are located vertically above the conveyor and vertically moveable relative to the conveyor.

15. The food processing system according to claim 11, wherein the plurality of pin chokes are a first plurality of pin chokes that extend toward the conveyor; and
wherein the second pin choke assembly includes a first plurality of pin chokes and a second plurality of pin chokes that extend away from the conveyor.

16. The food processing system according to claim 15, wherein the first plurality of pin chokes extend perpendicular to the second plurality of pin chokes.

17. The food processing system according to claim 15, wherein the second plurality of pin chokes extend toward the module.

18. A method for processing a food product in a food processing system, the method comprising:
processing, with a module configured to generate microwaves, the food product;
conveying, with a conveyor, the food product through the module;
moving a first pin choke assembly from a second position in which a second clearance distance is defined between the first pin choke assembly and the conveyor to a first position in which a first clearance distance is defined between the first pin choke assembly and the conveyor, wherein the first clearance distance is greater than the second clearance distance; and
moving a second pin choke assembly from a second position in which a second clearance distance is defined between the first pin choke assembly and the conveyor to a first position in which a first clearance distance is defined between the first pin choke assembly and the conveyor, wherein the first clearance distance is greater than the second clearance distance.

19. The method according to claim 18, further comprising:
sensing, with a sensor, a food product on a conveyor;
wherein the moving of the first pin choke assembly from the second position to the first position when the control system determines that the food product approaches the first pin choke assembly thereby permitting the food product to pass below the first pin choke assembly; and
wherein the moving of the second pin choke assembly from the second position to the first position when the control system determines that the food product approaches the second pin choke assembly thereby permitting the food product to pass below the second pin choke assembly.

20. The method according to claim 18, the method further comprising:
sensing, with a sensor, a leading end of the food product on the conveyor;
wherein the moving of the first pin choke assembly from the second position to the first position when the control system determines that the leading end of the food product approaches the first pin choke assembly thereby permitting the food product to pass below the first pin choke assembly;
wherein the moving of the second pin choke assembly from the second position to the first position occurs when the control system determines that the leading end of the food product approaches the first pin choke assembly thereby permitting the food product to pass below the first pin choke assembly;
sensing, with the sensor, a trailing end of the food product on the conveyor;
moving of the first pin choke assembly from the first position to the second position when the control system determines that the trailing end of the food product clears the first pin choke assembly to thereby prevent microwaves from leaking from the module; and
moving of the second pin choke assembly from the first position to the second position when the control system determines that the trailing end of the food product clears the second pin choke assembly to thereby prevent microwaves from leaking from the module.
